(19) United States
(12) Patent Application Publication
(10) Pub. No.: US 2024/0320554 A1
(43) Pub. Date: Sep. 26, 2024

(54) MODEL SETTING SUPPORT DEVICE, MODEL SETTING SUPPORT METHOD, AND STORAGE MEDIUM

(71) Applicant: HONDA MOTOR CO., LTD., Tokyo (JP)

(72) Inventors: Sho Nakajima, Wako-shi (JP); Atsushi Yamamoto, Wako-shi (JP); Jun Okano, Wako-shi (JP)

(21) Appl. No.: 18/585,118

(22) Filed: Feb. 23, 2024

(30) Foreign Application Priority Data
Mar. 20, 2023 (JP) 2023-044227

(51) Int. Cl. G06N 20/00

(52) U.S. Cl. CPC G06N 20/00

(57) ABSTRACT

A model setting support device includes a model learning unit having a plurality of learning models for estimating an objective variable indicating performance of a product from an explanatory variable group and configured to learn each of the plurality of learning models using training data including a dataset including the explanatory variable group and a target value of the objective variable, an analysis unit configured to execute first analysis for calculating a predicted value of the objective variable from the explanatory variable group and calculating prediction accuracy of the predicted value on the basis of the target value of the objective variable and second analysis for deriving a degree of contribution of the explanatory variable to the objective variable, for each learning model, and a learning result processing unit configured to output learning result information indicating the prediction accuracy and the contribution degree for each learning model.

### CROSS-REFERENCE TO RELATED APPLICATION

Priority is claimed on Japanese Patent Application No. 2023-044227, filed Mar. 20, 2023, the content of which is incorporated herein by reference.

### BACKGROUND OF THE INVENTION

### Field of the Invention

The present invention relates to a model setting support device, a model setting support method, and a storage medium.

### Description of Related Art

Machine learning is a process of finding a relationship between a factor and a result of a known case using training data about the case. Machine learning can be regarded as data processing for obtaining a mathematical model that expresses a relationship between an explanatory variable indicating the factor and an objective variable indicating the result using a computer. A learned mathematical model (which may be referred to as a “machine learning model,” “learning model,” “model,” or the like) is used to predict a result thereof from an unknown factor.

Machine learning is applied to various fields, for example, product design. In product design, a model is learned to predict specifications of parts or materials as explanatory variables and predict performance expected according to the specifications as an objective variable. On the other hand, in general, when the type of model is different, the prediction performance of the prediction result predicted using the learned model may be different. In the following Patent Document 1, a method for acquiring a plurality of models by executing a plurality of machine learning algorithms independently of each other and adopting a model with the highest prediction performance is disclosed. The method includes executing a plurality of machine learning algorithms on a computer using training data, calculating a rate of an increase in prediction performance of each of the plurality of models generated by the plurality of machine learning algorithms on the basis of results of executing the plurality of machine learning algorithms, selecting a mechanical learning model among a plurality of mechanical learning algorithms on the basis of the rate of the increase, and selecting a machine learning algorithm using other training data.

In the following Patent Document 2, a multiple regression analysis device for performing a multiple regression analysis on a plurality of datasets including a plurality of explanatory variables and an objective variable is disclosed. The multiple regression analysis device determines an explanatory variable that is valid as a parameter for stratification of a plurality of data items among the plurality of explanatory variables as a stratified explanatory variable, divides a plurality of datasets into layers using stratified explanatory variables, performs a multiple regression analysis on each of the groups of the plurality of divided datasets, and acquires an integrated multiple regression equation into which multiple regression analysis results are integrated.
[Patent Document 1] Japanese Unexamined Patent Application, First Publication No. 2017-49677
[Patent Document 2] Japanese Unexamined Patent Application, First Publication No. 2020-57261

### SUMMARY OF THE INVENTION

However, because the process described in Patent Document 1 is a model selection process based on prediction performance, a process of determining the validity of the model selected in consideration of knowledge of parts, materials, and the like is not included with respect to target data to be processed. The method described in Patent Document 2 is premised on the use of a multiple regression analysis, which is a data analysis method predetermined in dataset analysis, and the validity of the data analysis method is not determined.

An aspect according to the present invention has been made in view of the above circumstances and an objective of the present invention is to provide a model setting support device, a model setting support method, and a storage medium that can promote more appropriate model setting.

To solve the above-described problems, the present invention adopts the following aspects.

(1) According to an aspect of the present invention, there is provided a model setting support device including: a model learning unit having a plurality of learning models for estimating an objective variable indicating performance of a product from an explanatory variable group including a plurality of types of explanatory variables indicating at least a material or design matter of the product and configured to learn each of the plurality of learning models using training data including a dataset including the explanatory variable group and a target value of the objective variable; an analysis unit configured to execute first analysis for calculating a predicted value of the objective variable from the explanatory variable group and calculating prediction accuracy of the predicted value on the basis of the target value of the objective variable and second analysis for deriving a degree of contribution of the explanatory variable to the objective variable, for each learning model; and a learning result processing unit configured to output learning result information indicating the prediction accuracy and the contribution degree for each learning model.

(2) In the above-described aspect (1), the model learning unit may learn the plurality of learning models for each objective variable, the analysis unit may execute the first analysis and the second analysis for each objective variable, and the learning result processing unit may output the learning result information for each objective variable.

(3) In the above-described aspect (2), the model setting support device may include a learning setting unit configured to select a learning model for predicting the objective variable in accordance with an input manipulation, wherein the model learning unit may learn the selected learning model without learning an unselected learning model.

(4) In the above-described aspect (1), the model setting support device may include a learning setting unit configured to select an explanatory variable in accordance with an input manipulation, wherein the model learning unit may learn the learning model including an explanatory variable selected from the training data without including an unselected explanatory variable.

(5) In the above-described aspect (1), the model setting support device may include a learning setting unit configured to retrieve a hyperparameter for learning the learning model with higher prediction accuracy for each learning model.

(6) In the above-described aspect (1), the product may be a battery.

(7) According to an aspect of the present invention, there is provided a computer-readable non-transitory storage medium storing a program for causing a computer to function as the above-described aspect (1).

(8) According to an aspect of the present invention, there is provided a model setting support method to be executed by a model setting support device having a plurality of learning models for estimating an objective variable indicating performance of a product from an explanatory variable group including a plurality of types of explanatory variables indicating at least a material or design matter of the product, the model setting support method including: learning, by the model setting support device, each of the plurality of learning models using training data including a dataset including the explanatory variable group and a target value of the objective variable; executing, by the model setting support device, first analysis for calculating a predicted value of the objective variable from the explanatory variable group and calculating prediction accuracy of the predicted value on the basis of the target value of the objective variable and second analysis for deriving a degree of contribution of the explanatory variable to the objective variable, for each learning model; and outputting, by the model setting support device, learning result information indicating the prediction accuracy and the contribution degree for each learning model.

According to the aspect according to the present invention, it is possible to provide a model setting support device, a model setting support method, and a storage medium capable of promoting the setting of a more appropriate learning model.

According to the above-described aspects (1), (6), (7), and (8), learning result information indicating the prediction accuracy calculated for each learning model and the degree of contribution of each explanatory variable to the objective variable is output. Therefore, the prediction accuracy for each objective variable is ensured and the selection of a learning model that does not violate the knowledge of the relationship between the production condition and performance of the product is supported.

According to the above-described aspect (2), learning result information indicating the prediction accuracy calculated for each learning model and the degree of contribution of each explanatory variable to the objective variable is output for an individual objective variable. Therefore, the prediction accuracy for each objective variable is ensured and the selection of a learning model that does not violate the knowledge of the relationship between the production condition and performance of the product is supported.

According to the above-described aspect (3), a learning model to be learned is selected according to the user's instruction, and an unselected learning model is not a learning target. By narrowing down the learning models, an amount of processing related to model learning and an amount of data associated with processing can be reduced.

According to the above-described aspect (4), an explanatory variable for use in model learning is selected according to the user's instruction and an unselected explanatory variable is not used for model learning. By narrowing down the explanatory variables, it is possible to reduce an amount of processing related to model learning and an amount of data associated with processing. By selecting an explanatory variable that has a high contribution degree for the objective variable, prediction accuracy is ensured.

According to the above-described aspect (5), because a hyperparameter for learning a learning model that can calculate the predicted value of the objective variable with higher accuracy is retrieved, model learning is made further efficient.

### BRIEF DESCRIPTION OF THE DRAWINGS

FIG. 1 is a schematic block diagram showing an example of a configuration of a model setting support device according to the present embodiment.

FIG. 2 is a schematic block diagram showing an example of a hardware configuration of the model setting support device according to the present embodiment.

FIG. 3 is a conceptual diagram showing a model setting support process according to the present embodiment.

FIG. 4 is a conceptual diagram showing a relationship between information items related to the model setting support process according to the present embodiment.

FIG. 5 is a table showing a first calculation example of prediction accuracy by accuracy verification according to the present embodiment.

FIG. 6 is a table showing a second calculation example of prediction accuracy by accuracy verification according to the present embodiment.

FIG. 7 is a table showing a first calculation example of a degree of contribution by a feature quantity analysis according to the present embodiment.

FIG. 8 is a table showing a second calculation example of a degree of contribution by a feature quantity analysis according to the present embodiment.

### DETAILED DESCRIPTION OF THE INVENTION

Embodiments of the present invention will be described with reference to the drawings. FIG. 1 is a schematic block diagram showing an example of a configuration of a model setting support device 10 according to the present embodiment.

In the model setting support device 10, a plurality of learning models, which can estimate an objective variable indicating performance of a product from an explanatory variable group including a plurality of types of explanatory variables indicating at least materials or design matters of the product and can derive a correlation of an explanatory variable with the objective variable, are set. The model setting support device 10 learns a plurality of learning models using training data including a dataset including a group of explanatory variables and an actual measured value of the objective variable. Each dataset corresponds to one data sample. The model setting support device 10 executes the first analysis and the second analysis for each learning model. The first analysis includes a process of calculating the predicted value of the objective variable from the explanatory variable group and calculating the prediction accuracy of the predicted value calculated on the basis of the actual measured value of the objective variable. The second analysis derives a correlation of the explanatory variables with the objective variable. The model setting support device 10 outputs learning result information indicating a correlation with the prediction accuracy for each learning model.

In the present invention, the learning model is a function or processing procedure for predicting an objective variable from an explanatory variable group, indicates that a parameter set indicating the characteristics of the function or procedure is variable, and indicates a method of retrieving the parameter set. In the present invention, calculating the predicted value may be referred to as “prediction.” “Prediction” may be referred to as “estimation” or “inference.”

The model setting support device 10 includes a calculation processing unit 120, a storage unit 140, and an input/output unit 150.

The calculation processing unit 120 includes a data processing unit 122, a learning setting unit 124, a model learning unit 126, an analysis unit 128, and a learning result processing unit 130.

The data processing unit 122 acquires product data indicating the characteristics of individual products. The product data includes a plurality of datasets for each type of product. Individual datasets include production information and performance information. The production information includes one or more variables indicating information indicating one or both of the material and design matter of the product. The performance information includes one or more items of actual measured performance of a product produced in accordance with production requirements included in a dataset identical to that of the performance information. The actual measured value can also be regarded as an example of a target value of the objective variable to be predicted by the learning model.

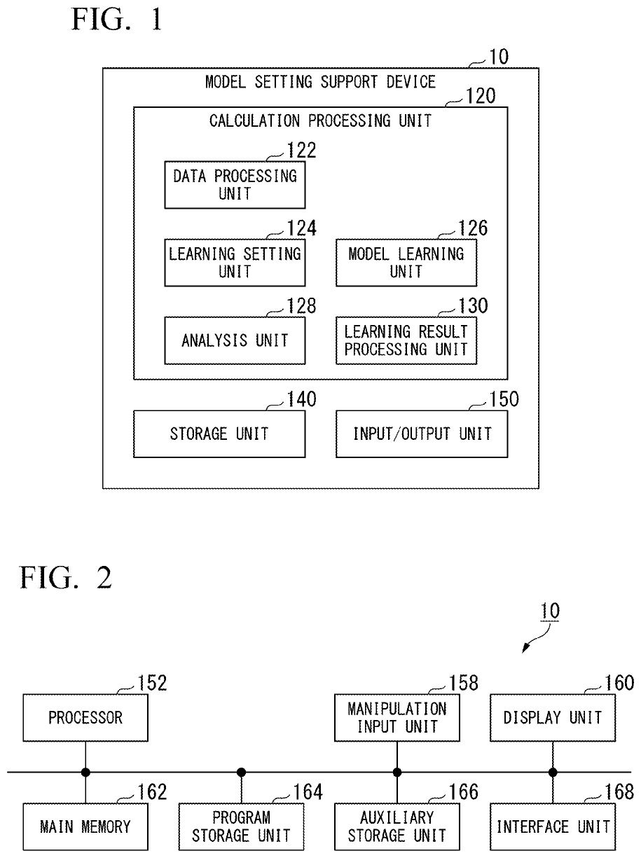

The data processing unit 122, for example, acquires product data from predetermined external equipment. The external equipment may be a general-purpose information device such as a server device having a product database, a personal computer, or a portable phone or a dedicated measuring instrument. The data processing unit 122 may construct product data by performing an editing process using various types of element information indicated in manipulation information input from a manipulation input unit 158 (FIG. 2). In the present invention, referring to the manipulation information input from the manipulation input unit 158 may be referred to as “in accordance with the manipulation.”

The data processing unit 122 performs preprocessing on individual datasets constituting the acquired product data, configures some processed datasets as training data (also referred to as “learning data”), and configures other processed datasets as verification data. Preprocessing includes, for example, a process of converting information of each item into that of a data format applicable or favorable to the learning of a learning model such as quantification or normalization. An individual dataset includes an explanatory variable group that is input to the learning model and an objective variable that gives a target value of an output from the learning model for the input. The data processing unit 122 stores the configured training data and verification data in the storage unit 140.

The present embodiment can be applied to products that have a dependence on production requirements such as materials or design matters in the implemented performance. The present embodiment can be applied, for example, to a battery (mainly, a storage battery capable of being iteratively charged and discharged and also referred to as a “secondary battery”) as such a product. When the product to be processed is a battery, for example, some or all items such as a material of an electrode or a blending ratio of a plurality of types of materials, an electrode length, and a thickness of the electrode are included in the explanatory variable group. As an index of performance given to the explanatory variable group, for example, capacitance, output, cost, and the like are applied as objective variables. The capacitance corresponds to an amount of charge obtained in a discharge process until a cut-off voltage is reached from the start of discharge when the output voltage between the two electrodes is the rated voltage. The output corresponds to the electric current or power obtained in a discharge process when the output voltage is equal to the rated voltage. The cost is the cost of manufacturing the product. The cost may include various expenses required for processing, distribution, and the like as well as the unit price of individual members.

The learning setting unit 124 sets various types of requirements related to model learning. The objective variable, the learning model, and the explanatory variable related to model learning are candidates for setting information. The learning setting unit 124 selects some or all of the objective variable, the learning model, and the explanatory variable from predetermined candidates in accordance with the manipulation information input from the manipulation input unit 158. When the learning result information is output from the learning result processing unit 130, the learning setting unit 124 selects a learning model and an explanatory variable for each objective variable. The learning setting unit 124 can select at least one type of learning model for at least one type of objective variable. The learning setting unit 124 may exclude candidates to be excluded indicated in the manipulation information from the predetermined candidates and select the remaining items. The learning setting unit 124 configures the selected learning model and a set of explanatory variables and objective variables selected in association with the learning model as a learning setting set. The learning setting unit 124 outputs learning setting information indicating the configured learning setting set to the model learning unit 126.

As a type of learning model, for example, a model related to linear regression and a model related to nonlinear regression are broadly classified. Linear regression refers to a statistical method of clarifying a relationship with an objective variable for an explanatory variable under the assumption that a model indicating the relationship is a linear prediction function. In the present embodiment, as a method related to a linear regression, a regression analysis method such as a multiple regression analysis, ridge regression (Ridge), least absolute shrinkage and selection operator (LASSO) regression, or elastic net can be applied. Nonlinear regression refers to a statistical method of clarifying a nonlinear relationship with an objective variable for an explanatory variable using a mathematical model indicating the relationship. As a mathematical model related to nonlinear regression, known methods such as a support vector machine (SVR), a neural network, AdaBoost, gradient boosting, and random forest can be applied.

The learning setting unit 124 sets hyperparameters for use in learning the set learning model. In the learning setting unit 124, initial values of hyperparameters are set in advance for each learning setting set indicating an explanatory variable group, an objective variable, and a learning model. In the present embodiment, explanatory variable groups that do not completely match the explanatory variables that serve as elements are treated as different explanatory variable groups. The learning setting unit 124 may perform hyperparameter tuning for each learning setting set indicating the selected explanatory variable group, the objective variable, and the learning model and retrieve more suitable hyperparameters. When hyperparameters are preferred, this indicates one or both of the convergence of the learning model at an earlier stage and the achievement of higher prediction accuracy, for example, in model learning.

In the parameter tuning, the learning setting unit 124 uses training data including a group of explanatory variables and an objective variable shown in an individual learning setting set. The learning setting unit 124 may associate the retrieved hyperparameters with the learning setting set indicating the set explanatory variable group, the objective variable, and the learning model, include them in the learning setting information, and output the learning setting information to the model learning unit 126. The learning setting unit 124 may further associate a parameter set of the learning model obtained in a process of retrieving hyperparameters (which may be referred to as “model parameters” or simply a “learning model” in the present invention), include it in the learning setting information and output the learning setting information to the model learning unit 126.

The model learning unit 126 executes model learning on the basis of the learning setting information input from the learning setting unit 124.

The model learning unit 126 learns the learning model indicated in the learning setting set for each learning setting set indicated in the learning setting information. In the present invention, “learning a learning model,” “learning of a learning model” or “model learning” includes the meaning of retrieving a parameter set of the learning model. In the learning of the learning model, the learning model is learned so that the explanatory variables indicated in the learning set are taken as an input and an evaluation value of a predetermined loss function indicating a magnitude of a difference between a predicted value calculated using the learning model indicated in the learning setting set and an actual measured value of the objective variable indicated in the learning setting set is reduced in the entire training data. The loss function can differ according to a learning model. For example, in model learning based on a multiple regression analysis, a weighted sum of squared differences between predicted values and actual measured values is used as a loss function. The weight coefficient group used in the calculation of the sum of squared differences corresponds to a hyperparameter. In model learning based on ridge regression, an L1 norm is included as a component of the loss function. In model learning based on Lasso regression, an L2 norm is included as a component of the loss function. The model learning unit 126 determines whether or not the learning has converged depending on whether or not the evaluation value of the loss function is less than or equal to the reference value of the predetermined evaluation value. When it is determined that the learning has converged, the model learning unit 126 stops the learning and stores the learned parameter set indicating the parameter set obtained at that time in the storage unit 140.

The analysis unit 128 refers to the learned parameter set stored in the storage unit 140, performs first analysis using evaluation data corresponding to the training data used for learning the learning model for estimating the objective variable for each set of the learned learning model and the objective variable, and performs second analysis on the basis of a learning model for estimating the objective variable. The first analysis corresponds to the verification of accuracy for the predicted value of the objective variable calculated using the learning model. For each dataset included in the evaluation data, the analysis unit 128 calculates the predicted value of the objective variable using the learned learning model from the explanatory variable group included in the dataset. The analysis unit 128 calculates a magnitude of the difference between the calculated prediction value and the predicted value, i.e., an index value (score) indicating the prediction accuracy. The analysis unit 128 aggregates the prediction accuracy index value calculated for each set of the learning model and the objective variable and outputs prediction accuracy information indicating the aggregated prediction accuracy to the learning result processing unit 130.

The analysis unit 128 may use, for example, any statistical amount such as a decision coefficient (R²), a mean square error (MSE), a root mean square error (RMSE), a mean absolute error (MAE), a mean absolute percentage error (MAPE), a symmetric mean absolute percentage error (SMAPE), or a maximum error ratio (MER) as an index value.

The decision coefficient R², the mean squared error MSE, the root mean square error RMSE, the mean absolute error MAE, the mean absolute percentage error MAPE, the symmetric mean absolute percentage error SMAPE, and the maximum error ratio MER are calculated using Eqs. (1), (2), (3), (4), (5), (6), and (7), respectively. In Eqs. (1) to (7), yᵢ denotes an actual measured value of the objective variable in a dataset i. ŷᵢ denotes a predicted value of the objective variable in the dataset i. n denotes a predetermined integer of 2 or more indicating the number of datasets used for accuracy verification.

$${R}^{2} = 1 - \frac{{\sum }_{i = 1}^{n} {( {y}_{i} - {\hat{y}}_{i} )}^{2}}{{\sum }_{i = 1}^{n} {( {y}_{i} - \overline{y} )}^{2}} \qquad ( 1 )$$

$$MSE = \frac{1}{n} {\sum }_{i = 1}^{n} {( {y}_{i} - {\hat{y}}_{i} )}^{2} \qquad ( 2 )$$

$$RMSE = \sqrt{\frac{1}{n} {\sum }_{i = 1}^{n} {( {y}_{i} - {\hat{y}}_{i} )}^{2}} \qquad ( 3 )$$

$$MAE = \frac{1}{n} {\sum }_{i = 1}^{n} \vert {y}_{i} - {\hat{y}}_{i} \vert \qquad ( 4 )$$

$$MAPE ( \% ) = \frac{100}{n} {\sum }_{i = 1}^{n} \vert \frac{{y}_{i} - {\hat{y}}_{i}}{{y}_{i}} \vert \qquad ( 5 )$$

$$SMAPE ( \% ) = \frac{100}{n} {\sum }_{i = 1}^{n} \vert \frac{( {y}_{i} - {\hat{y}}_{i} )}{( \vert {y}_{i} \vert - \vert {\hat{y}}_{i} \vert )} \vert \qquad ( 6 )$$

$$MER ( \% ) = 100 \times max \vert \frac{{y}_{i} - {\hat{y}}_{i}}{{y}_{i}} \vert \qquad ( 7 )$$

The decision coefficient R² is a real value between 0 and 1 and it is indicated that the prediction accuracy is higher when the decision coefficient R² is closer to 1. In general, the decision coefficient tends to approximate to 1 as the number of elements of the explanatory variables that are the elements of the explanatory variable group increases.

The mean squared error MSE is a real value greater than or equal to 0 and it is indicated that the prediction accuracy is higher when the mean squared error MSE is closer to 0. The mean squared error is more likely to indicate the magnitude of the error of the objective variable as a whole than the mean absolute error.

The root mean square error RMSE corresponds to the square root of the mean square error and the increase in its absolute value is suppressed as compared with the mean square error. The root mean square error may be often used in predictive evaluation of regression problems.

The mean absolute error MAE is a positive real value greater than or equal to 0 and it is indicated that the prediction accuracy is higher when the mean absolute error MAE is closer to 0. Because the mean absolute error is proportional to a margin of error of the individual objective variables, it tends to be susceptible to outliers of the individual objective variables.

The mean absolute percentage error MAPE is a real value of 0 or more and it is indicated that the prediction accuracy is higher when the mean absolute percentage error MAPE is closer to 0%. The mean absolute percentage error indicates the absolute deviation of the explanatory variables as a whole. Because the mean absolute percentage error is proportional to the ratio of error to the actual measured value of the individual explanatory variables, it tends to be susceptible to the percentage error of the individual explanatory variables. Because the predicted value of each explanatory variable is normalized by dividing it by the actual measured value, it cannot be used when the actual measured value contains 0.

The symmetric mean absolute percentage error SMAPE is a real value greater than or equal to 0 and it is indicated that the prediction accuracy is higher when symmetric mean absolute percentage error SMAPE is closer to 0%. The symmetric mean absolute percentage error is given using a difference between the absolute value of the actual measured value and the absolute value of the predicted value instead of the measured value in the mean absolute percentage error. The symmetric mean absolute percentage error rate can be used even if the actual measured value contains zero, as long as the difference between the absolute value of the actual measured value and the absolute value of the predicted value does not become zero.

The maximum error ratio MER is a real value of 0 or more and it is indicated that the prediction accuracy is higher when the maximum error ratio MER is closer to 0%. The maximum error ratio corresponds to a maximum value of a ratio of the absolute value of the difference between the actual measured value and the predicted value to the absolute value of the actual measured value of an individual explanatory variable. Therefore, errors for specific explanatory variables are likely to appear.

Thus, each index value has its own unique characteristics. The analysis unit 128 may predetermine the type of index value to be calculated for each objective variable to be calculated.

The second analysis corresponds to feature quantity analysis for deriving a feature quantity indicating a degree of contribution of an individual explanatory variable to the objective variable calculated using the learning model. The analysis unit 128 derives the degree of contribution of the individual explanatory variable to the objective variable from the learned learning model used to predict the objective variable from the explanatory variable group. For example, when the learning model is a multiple regression analysis, ridge regression, lasso regression, elastic net, or the like based on a linear model, the analysis unit 128 can extract a statistic such as a partial regression coefficient for each explanatory variable for the objective variable from the parameter set of the learned learning model as the degree of contribution of the explanatory variable to the objective variable. The analysis unit 128 may adopt a standardized partial regression coefficient obtained by multiplying the extracted partial regression coefficient by the standard deviation of the explanatory variable and performing a division operation on the standard deviation of the objective variable as the degree of contribution of the explanatory variable to the objective variable.

When the learning model is a mathematical model based on a nonlinear model, the analysis unit 128 can calculate any statistic such as local interpretable model-agnostic explanations (LIME) or Shapley additive explanations (SHAP) as the degree of contribution of the explanatory variable to the objective variable. The analysis unit 128 aggregates the degree of contribution of the explanatory variable to the objective variable for each set of the learning model and the objective variable and outputs contribution degree information indicating the aggregated contribution degree to the learning result processing unit 130.

The learning result processing unit 130 outputs prediction accuracy information and contribution degree information input from the analysis unit 128 as learning result information to the display unit 160. Output timings of the prediction accuracy information and the contribution degree information may not necessarily be simultaneous or may be different. For example, the learning result processing unit 130 generates a display screen by arranging one or both of the prediction accuracy information and the contribution degree information in accordance with a predetermined screen arrangement and outputs display data indicating the generated display screen to the display unit 160. The display unit 160 displays the display screen in accordance with the display data input from the learning result processing unit 130.

The learning result processing unit 130, for example, generates a prediction accuracy display screen as a display screen representing prediction accuracy information for each objective variable. The learning result processing unit 130 prioritizes the order as the prediction accuracy for each set of the learning model and the objective variable increases and arranges a numerical value or a figure (for example, an individual bar without a bar graph) indicating the prediction accuracy index value. For example, the learning result processing unit 130 generates a contribution degree display screen as a display screen indicating contribution degree information for each set of the learning model and the objective variable. The learning result processing unit 130 arranges the numerical value or the figure indicating the contribution degree by prioritizing the order as the degree of contribution of each explanatory variable to the objective variable increases.

The learning result processing unit 130 determines whether the prediction accuracy display screen or the contribution degree display screen is to be displayed on the display unit 160 according to the operation. The learning result processing unit 130 determines an objective variable to be displayed as prediction accuracy information in accordance with a manipulation on the prediction accuracy display screen. The learning result processing unit 130 determines a set of a learning model and an objective variable to be displayed as the contribution degree information in accordance with a manipulation on the contribution degree display screen. For example, the learning result processing unit 130 changes the display target in a predetermined order every time the manipulation is detected. The learning result processing unit 130 may include a selection screen indicating a list of candidates to be displayed on the display screen to display the display screen and select the candidate indicated in accordance with the manipulation as a display target.

The user can ascertain the prediction accuracy of the learning model differing according to each objective variable by visually recognizing the prediction accuracy display screen displayed on the display unit 160 and ascertain a correlation relationship between the different explanatory variable group and the objective variable by visually recognizing the contribution degree display screen. The user can select the learning model and the explanatory variable group for use in the prediction of the objective variable according to a manipulation while suppressing the decrease in prediction accuracy and efficiency by comprehensively considering the prediction accuracy, which is a statistic, and the correlation relationship between the explanatory variable group corresponding to the production requirement of the product and the objective variable. In the selection, data science knowledge and professional knowledge such as a material or design matter of a product related to the explanatory variable for acquiring the contribution degree to be displayed are reflected for the prediction accuracy to be displayed.

The learning setting unit 124 selects one or more types of learning models to be learned for each objective variable in accordance with a manipulation during the display of the display screen as described above. The learning setting unit 124 may be able to select one or more types of objective variables used for product evaluation in accordance with a manipulation. For each type of objective variable in the prediction accuracy display screen, the learning model is preferentially presented as the prediction accuracy increases. The learning setting unit 124 may select a learning model related to prediction accuracy greater than or equal to that of a learning model indicated in accordance with a manipulation and reject other learning models. The learning setting unit 124 selects an explanatory variable for use in the model learning for each set of the objective variable and the selected learning model in accordance with the manipulation. In the contribution degree display screen, the explanatory variable is presented to each objective variable as the contribution degree increases with respect to a set of an individual objective variable and a learning model. The learning setting unit 124 may select an explanatory variable related to a contribution degree higher than or equal to that of the learning model indicated in accordance with a manipulation and reject other explanatory variables.

In the learning setting unit 124, reference prediction accuracy may be set in advance for each objective variable and a learning model in which the prediction accuracy is higher than or equal to the reference prediction accuracy may be selected. The learning setting unit 124 may set the reference prediction accuracy on the basis of the prediction accuracy related to the learning model selected in accordance with the manipulation for each objective variable. When there are a plurality of types of selected learning models, the reference prediction accuracy may be set on the basis of the lowest prediction accuracy among the prediction accuracies related to the selected learning models. For example, the learning setting unit 124 can determine prediction accuracy that is lower than the prediction accuracy related to the selected learning model or lower than the prediction accuracy by a predetermined margin value as the reference prediction accuracy.

In the learning setting unit 124, a reference contribution degree may be set in advance for each set of the objective variable and the learning model and an explanatory variable having a contribution degree higher than or equal to the reference contribution degree may be selected. The learning setting unit 124 may set the reference contribution degree on the basis of the contribution degree related to the learning model selected in accordance with the manipulation for each set of the objective variable and the learning model. When there are a plurality of types of selected explanatory variables, the reference contribution degree may be set on the basis of the lowest contribution degree among the contribution degrees related to the selected learning model. For example, the learning setting unit 124 can determine a contribution degree related to the selected explanatory variable or a contribution degree lower than the contribution degree by a predetermined margin value as the reference contribution degree.

The learning setting unit 124 may select one or more types of index values from index values of a plurality of types of prediction accuracy set in advance for each objective variable in accordance with the manipulation. The learning setting unit 124 sets the selected type of index value in the analysis unit 128. When a plurality of types of index values are applied, the learning result processing unit 130 may change the type of index value of the prediction accuracy to be output in accordance with the manipulation or may output these types of index values at the same time.

Even for the learning model whose prediction accuracy is higher than the reference prediction accuracy, it may or may not be selected in accordance with the manipulation and in accordance with the degree of contribution of the explanatory variable to the objective variable. Therefore, for each set of an explanatory variable group, an objective variable, and a learning model, the learning setting unit 124 may record whether or not the learning model is selected in accordance with the manipulation and a probability that the learning model will be selected may be determined as a selection probability. Under a predetermined probability distribution model (for example, a linear combination of a multidimensional Gaussian distribution function), the learning setting unit 124 may determine a probability distribution applicable to the determined selection probability for each set of the objective variable and the learning model on the parameter space of the explanatory variable group. The learning setting unit 124 can estimate a selection probability for a new explanatory variable group for a set of a known objective variable and a learning model using a defined probability distribution. When the estimated selection probability is greater than or equal to a lower limit of the predetermined selection probability and the prediction accuracy is greater than or equal to the reference prediction accuracy, the learning setting unit 124 may determine the learning model for the objective variable as a candidate model. The learning setting unit 124 may include candidate model information indicating a predetermined candidate model in the display screen and cause the display unit 160 to display the display screen.

The storage unit 140 stores various types of data temporarily or permanently.

The input/output unit 150 can input or output various types of input data to or from another device.

Instead of outputting various types of display data to the display unit 160, the learning result processing unit 130 may output the display data to another device via the input/output unit 150.

The data processing unit 122 and the learning setting unit 124 may input various types of manipulation information from another device via the input/output unit 150 instead of inputting various types of manipulation information from the manipulation input unit 158. The other device may be connected via a communication network.

Next, an example of a hardware configuration of the model setting support device 10 according to the present embodiment will be described. FIG. 2 is a schematic block diagram showing the example of the hardware configuration of the model setting support device 10 according to the present embodiment. The model setting support device 10 is configured to include a processor 152, a manipulation input unit 158, a display unit 160, a main memory 162, a program storage unit 164, an auxiliary storage unit 166, and an interface unit 168. The processor 152, the manipulation input unit 158, the display unit 160, the main memory 162, the program storage unit 164, the auxiliary storage unit 166, and the interface unit 168 are connected by a bus, and can input/output various types of data to each other.

The processor 152 executes a calculation process indicated in an instruction described in various types of programs. The processor 152 controls an operation of the entire model setting support device 10. The processor 152 is, for example, a central processing unit (CPU). In the present invention, executing the calculation process indicated in the instruction described in the program may be referred to as “executing the program.”

The manipulation input unit 158 can receive a manipulation and generates a manipulation signal in accordance with the received manipulation. Various types of manipulation information are indicated in manipulation signals. The manipulation input unit 158 may include general-purpose members such as a mouse, a touch sensor, and a keyboard or may have dedicated members such as a button and a dial.

The display unit 160 displays a display screen according to the display data input to the display unit 160. The display unit 160 may be any one of a liquid crystal display, an organic electroluminescent display, and the like.

The main memory 162 is a writable memory used as a reading area for the executable program of the processor 152 or as a work area for writing the processing data of the executable program. The main memory 162 is configured to include, for example, a random-access memory (RAM).

The program storage unit 164 stores system firmware such as a basic input output system (BIOS), firmware of various types of devices, other programs, and setting information required for executing the programs. The program storage unit 164 is configured to include, for example, a read-only memory (ROM).

The auxiliary storage unit 166 permanently stores various types of data and programs to be rewritable. The auxiliary storage unit 166 may be, for example, any one of a hard disk drive (HDD), a solid-state storage device (solid-state drive (SSD)), and the like.

The interface unit 168 are connected to other devices by wire or wirelessly so that various types of data can be input/output. The interface unit 168 includes one or both of an input/output interface and a communication interface.

The processor 152 and the main memory 162 correspond to the minimum hardware used to implement the computer system of the model setting support device 10. The processor 152 mainly implements the function of the calculation processing unit 120 by executing a predetermined program in cooperation with the main memory 162 and other hardware. The main memory 162, the program storage unit 164, and the auxiliary storage unit 166 implements the main functions of the storage unit 140. The interface unit 168 implements the main functions of the input/output unit 150.

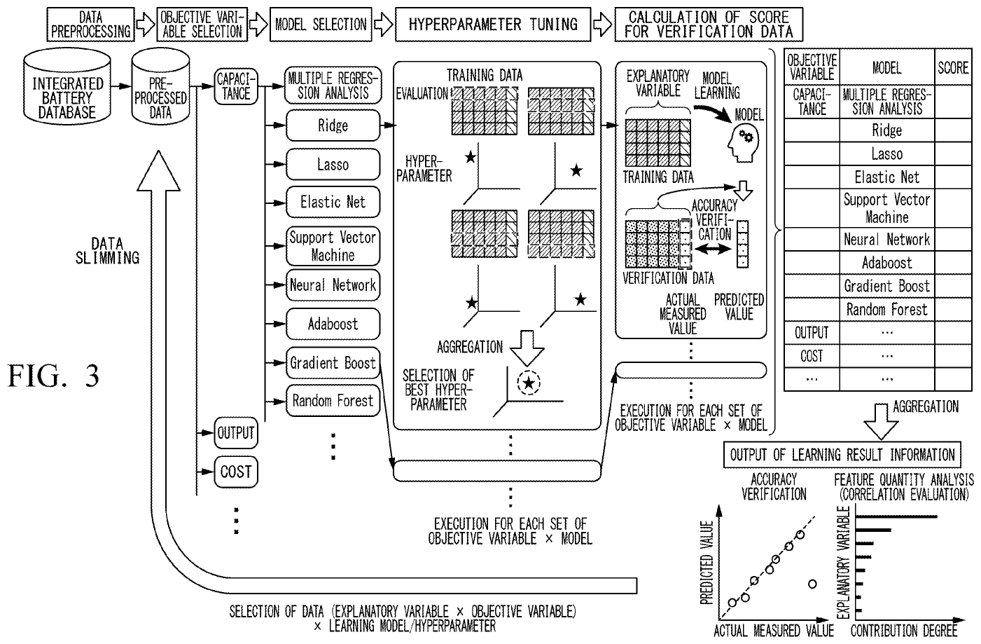

Next, an example of the model setting support process according to the present embodiment will be described. FIG. 3 is a conceptual diagram showing the example of the model setting support process according to the present embodiment. In the example of FIG. 3, the model setting support device 10 according to the present embodiment can access an integrated battery database. The integrated battery database constitutes an example of a product database. The integrated battery database stores product data indicating characteristics of individual batteries. The integrated battery database is constructed in a predetermined server device and is connected to the model setting support device 10 using a communication network by wire or wirelessly.

The data processing unit 122 of the model setting support device 10 acquires product data from the integrated battery database. The data processing unit 122 performs preprocessing on the acquired product data, configures training data and verification data as preprocessed data, and stores the data in the storage unit 140.

The learning setting unit 124 sets an objective variable to be predicted. In the example of FIG. 3, before the initial model learning, the capacitance, output, cost, and the like are set in advance as index values related to the performance of the battery.

The learning setting unit 124 selects a learning model to be learned. In the example of FIG. 3, before the initial model learning, a multiple regression analysis, ridge regression, lasso regression, elastic net, support vector machine, neural network, AdaBoost, gradient boosting, random forest, and the like are set in advance for each objective variable as a learning model.

In the learning setting unit 124, a setting variable group for use in predicting the objective variable is set in advance for each selected set of the objective variable and the learning model.

The learning setting unit 124 sets hyperparameters determined by performing hyperparameter tuning using training data as hyperparameters for use in model learning in the model learning unit 126 for each set of the objective variable and the learning model that has been set. In the example of FIG. 3, a grid search is applied in the hyperparameter tuning. The grid search is a method of performing accuracy verification in the round-robin from candidates for a plurality of predetermined hyperparameters and selecting a hyperparameter for giving the highest prediction accuracy. The grid search includes a process of performing model learning using a part of the training data for each hyperparameter candidate and calculating a predicted value of an objective variable from an explanatory variable group constituting another part of the training data using the learned learning model. In the accuracy verification, any of the above-described index values is calculated with reference to the target value of the objective variable constituting another part of the training data for the calculated predicted value. In the hyperparameter tuning, other methods such as, for example, a random search, Bayesian optimization, may be used.

The model learning unit 126 performs model learning using training data for each set of an objective variable and a learning model. In the model learning, the model learning unit 126 determines model parameters of the learning model so that the predicted value of the objective variable calculated from the explanatory variable is approximate to the actual measured value of the objective variable.

The analysis unit 128 performs accuracy verification using verification data for each set of the objective variable and the learned learning model. In the accuracy verification (first analysis), the analysis unit 128 calculates an index value (score) of the prediction accuracy indicating a degree to which the predicted value of the objective variable calculated from the explanatory variable is approximate to the actual measured value of the objective variable. The analysis unit 128 aggregates the index value of the prediction accuracy calculated for each set of the objective variable and the learning model. In feature quantity analysis (second analysis), the analysis unit 128 derives a degree of contribution of each explanatory variable to the objective variable for each set of the objective variable and the learned learning model. The analysis unit 128 aggregates the derived degree of contribution of the explanatory variable to the objective variable for each set of the objective variable and the learning model.

The learning result processing unit 130 outputs aggregated prediction accuracy information and contribution degree information as learning result information to the display unit 160 and causes a prediction accuracy display screen indicating an accuracy verification result and a contribution degree display screen indicating a feature quantity analysis result to be displayed. Thereby, the user is prompted to select an objective variable, select a learning model for each selected objective variable, and select an explanatory variable.

The learning setting unit 124 selects an objective variable to be evaluated in accordance with a manipulation. According to the selection of the objective variable, for example, an objective variable that causes a significant difference between product types can be adopted and other objective variables may be rejected. The learning setting unit 124 selects a learning model to be learned for each objective variable in accordance with a manipulation. According to the selection of the learning model, for example, a learning model capable of accurately predicting the objective variable may be adopted and other learning models may be rejected. According to the selection of the explanatory variable, for example, an explanatory variable with a high degree of contribution to the objective variable may be selected and other explanatory variables may be rejected.

The learning setting unit 124 sets the selected objective variable, the learning model for each objective variable, and the explanatory variable for each set of the objective variable and the learning model in the model learning unit 126. According to the selection of such data and the selection of the learning model, the amount of data related to model learning, the amount of processing, and the like can be reduced (slimming). The learning setting unit 124 determines hyperparameters for each selected set of the objective variables and the learning model and sets the determined hyperparameters in the model learning unit 126. Consequently, the efficiency of model learning that ensures prediction accuracy is supported by iterating model learning, accuracy verification, feature quantity analysis, and learning settings.

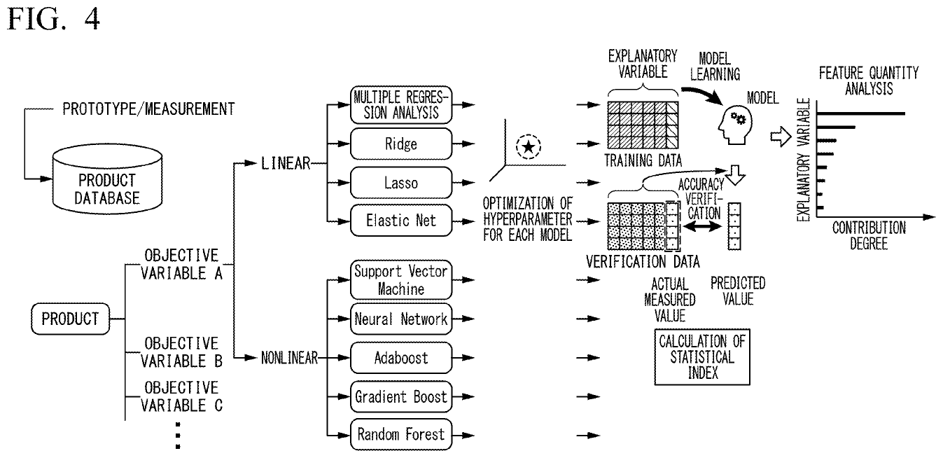

FIG. 4 is a conceptual diagram showing a relationship between information items related to the model setting support process according to the present embodiment. The product database stores product data indicating characteristics of a product of each prototyped and measured model. A number of datasets included in product data include one or more explanatory variables and one or more objective variables. In the example of FIG. 4, the objective variables A, B, and C are included in each dataset. A plurality of learning models are used in the prediction of individual objective variables.

The plurality of learning models are classified into linear and nonlinear models. A linear model is a mathematical model that has linearity in the individual explanatory variable and the objective variable. In the linear model, a multiple regression analysis, ridge regression, lasso regression, and elastic nets, and the like are classified. A nonlinear model is a mathematical model that has nonlinearity in at least one explanatory variable and the objective variable. In the nonlinear model, support vector machines, neural networks, AdaBoost, gradient boosting, random forests, and the like are classified. The learning setting unit 124 optimizes hyperparameters by performing hyperparameter tuning for each learning model. The model learning unit 126 executes model learning using training data for the selected learning model under the optimized hyperparameters. The analysis unit 128 calculates a statistical index indicating the prediction accuracy by performing the accuracy verification using the verification data with respect to the learned learning model. In the feature quantity analysis, the analysis unit 128 analyzes the degree of contribution of the explanatory variable to the objective variable to be predicted on the basis of the learned learning model.

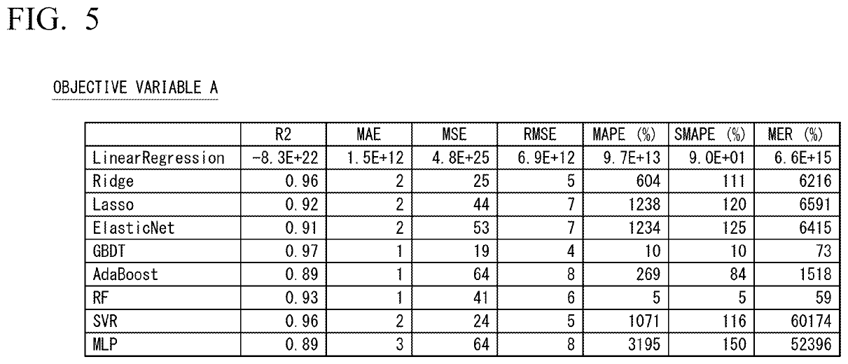

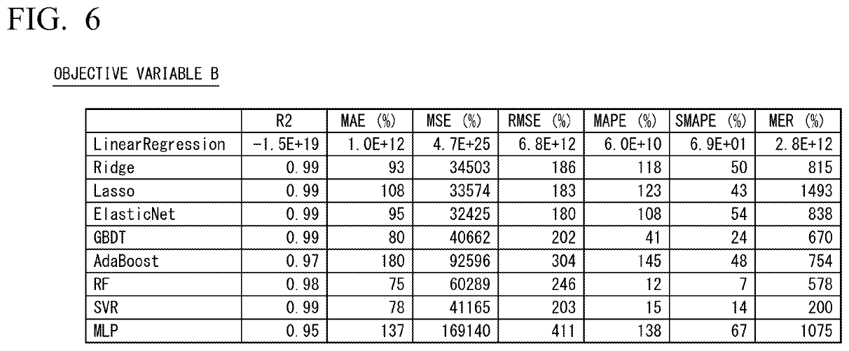

Next, an example of calculation of prediction accuracy in the accuracy verification according to the present embodiment will be described. FIGS. 5 and 6 are tables showing examples of the calculation of the prediction accuracy. FIGS. 5 and 6 show index values of the prediction accuracy calculated for sets of learning models and types of index values for objective variable A and objective variable B, respectively. Each row and column correspond to the learning model and the type of index value, respectively. In the examples of FIGS. 5 and 6, differences in MAPE, SMAPE, and MER due to the learning model instead of the other index values are noticeably shown.

If SMAPE is adopted as the accuracy verification index value, the prediction accuracy of the predicted value based on random forest (RF) is evaluated as the highest accuracy for objective variable A and the prediction accuracy of the predicted value based on gradient boosting (GBDT) is evaluated as the next highest accuracy. These prediction accuracies are significantly different from the prediction accuracies of other learning models. Therefore, the user is prompted to select a random forest and gradient boosting.

For objective variable B, the prediction accuracy of the predicted value based on random forest is evaluated as the highest accuracy and the prediction accuracy of the predicted value based on the support vector machine (SVR) is evaluated as the next highest accuracy. These prediction accuracies are significantly different from the prediction accuracies of other learning models. Therefore, the user is prompted to select a random forest and a support vector machine.

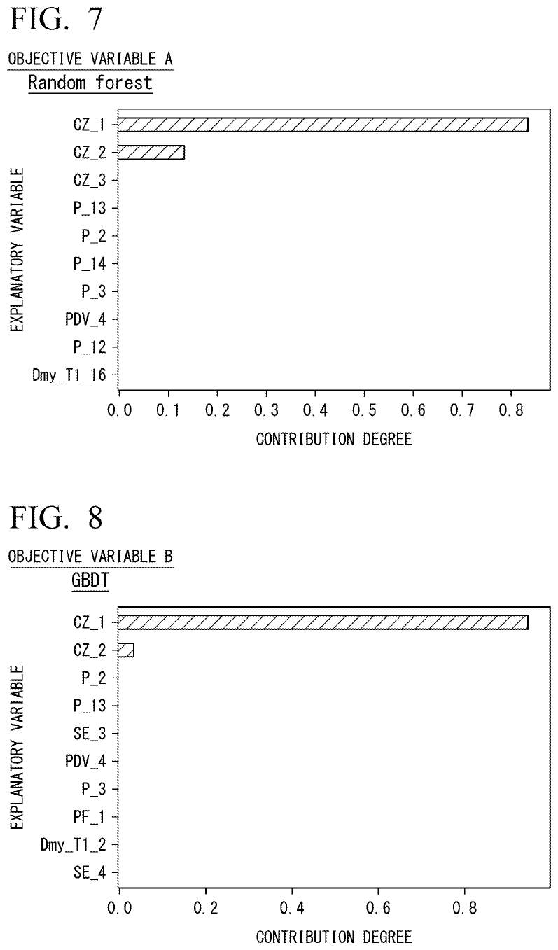

Next, an example of derivation of a contribution degree in feature quantity analysis according to the present embodiment will be described. FIGS. 7 and 8 are diagrams showing examples of calculation of prediction accuracy. FIG. 7 shows an example of the contribution degrees of individual explanatory variables when the random forest is used as a learning model for predicting objective variable A. The vertical and horizontal axes of FIG. 7 represent an explanatory variable and a contribution degree, respectively. FIG. 7 shows contribution degrees of explanatory variables in descending order. According to FIG. 7, CZ_1 denotes the highest degree of contribution to objective variable A and CZ_2 denotes the next highest degree of contribution thereto. The contribution degrees of CZ_1 and CZ_2 are different from the degrees of contribution to other objective variables A and are significantly greater than 0. Therefore, the user is prompted to select CZ_1 and CZ_2.

FIG. 8 shows an example of contribution degrees of individual explanatory variables when gradient boosting is used as a learning model for predicting objective variable B. According to FIG. 8, CZ_1 denotes the highest degree of contribution to objective variable B and CZ_2 denotes the next highest degree of contribution thereto. The contribution degrees of CZ_1 and CZ_2 are different from the degrees of contribution to other objective variables B and are significantly greater than 0. Therefore, the user is prompted to select CZ_1 and CZ_2.

However, if the degree of contribution of each derived explanatory variable to the objective variable is different from the knowledge of the product performance of the production condition of a part, a material, or the like, for example, an influence on performance indicated in the objective variable according to the production condition described in the explanatory variable may be contrary to the physical phenomenon. In this case, the user is prompted to reject a learning model used for predicting the objective variable without selecting the learning model and select another learning model. Therefore, as in the present embodiment, the selection of a learning model that does not violate the knowledge of a relationship between a production condition and performance of a product while ensuring the prediction accuracy is supported by presenting the prediction accuracy and the contribution degree as learning results.

Although the example in which the model setting support device 10 is connected to the manipulation input unit 158 and the display unit 160 by wire or wireless, manipulation information is input from the manipulation input unit 158, and display data is output to the display unit 160 has been described above, the present invention is not limited thereto. An input source of the manipulation information and an output destination of the display data may be external devices connected using a network. In that case, in the model setting support device 10, one or both of the manipulation input unit 158 and the display unit 160 may be omitted.

Although the case where the target value for the predicted value of the objective variable calculated using the learning model from the explanatory variable group is the actual measured value has been mainly described, the present invention is not limited thereto. The target value may be a value set in accordance with the manipulation as long as it is a known numerical value serving as a target for the predicted value of the calculated objective variable.

As described above, according to the present embodiment, the model setting support device 10 includes: the model learning unit 126 having a plurality of learning models for estimating an objective variable indicating performance of a product from an explanatory variable group including a plurality of types of explanatory variables indicating at least a material or design matter of the product and configured to learn each of the plurality of learning models using training data including a dataset including the explanatory variable group and a target value of the objective variable; the analysis unit 128 configured to execute first analysis (for example, accuracy verification) for calculating a predicted value of the objective variable from the explanatory variable group and calculating prediction accuracy of the predicted value on the basis of the target value of the objective variable and second analysis (for example, feature quantity analysis) for deriving a degree of contribution of the explanatory variable to the objective variable, for each learning model; and the learning result processing unit 130 configured to output learning result information indicating the prediction accuracy and the contribution degree for each learning model. The product is, for example, a battery.

A program according to the present embodiment may be implemented as a program for causing the computer to function as the model setting support device 10.

According to this configuration, learning result information indicating the prediction accuracy calculated for each learning model and the degree of contribution of each explanatory variable to the objective variable is output. The user who has received the prediction accuracy and contribution degree can compare the production condition of the product described in the contribution degree and the explanatory variable with knowledge about the performance of the product indicated in the objective variable without relying only on the prediction accuracy. Therefore, the prediction accuracy of the objective variable is ensured and the selection of a learning model that does not violate the knowledge of the relationship between the production condition and performance of the product is supported.

The model learning unit 126 may learn the plurality of learning models for each objective variable, the analysis unit 128 may execute the first analysis and the second analysis for each objective variable, and the learning result processing unit 130 may output the learning result information for each objective variable.

According to this configuration, learning result information indicating the prediction accuracy calculated for each learning model and the degree of contribution of each explanatory variable to the objective variable is output for an individual objective variable. Therefore, the prediction accuracy for each objective variable is ensured and the selection of a learning model that does not violate the knowledge of the relationship between the production condition and performance of the product is supported.

The model setting support device may include the learning setting unit 124 configured to select a learning model for predicting the objective variable in accordance with an input manipulation, wherein the model learning unit 126 may learn the selected learning model without learning an unselected learning model.

According to this configuration, a learning model to be learned is selected according to the user's instruction, and an unselected learning model is not a learning target. By narrowing down the learning models, an amount of processing related to model learning and an amount of data associated with processing can be reduced.

The model setting support device may include the learning setting unit 124 configured to select an explanatory variable in accordance with an input manipulation, wherein the model learning unit 126 may learn the learning model including an explanatory variable selected from the training data without including an unselected explanatory variable.

According to this configuration, an explanatory variable for use in model learning is selected according to the user's instruction and an unselected explanatory variable is not used for model learning. By narrowing down the explanatory variables, it is possible to reduce an amount of processing related to model learning and an amount of data associated with processing. By selecting an explanatory variable that has a high contribution degree for the objective variable, prediction accuracy is ensured.

The model setting support device may include the learning setting unit 124 configured to retrieve a hyperparameter for learning the learning model with higher prediction accuracy for each learning model.

According to this configuration, hyperparameters for learning a learning model with higher prediction accuracy are retrieved. Model learning is made efficient so that a learning model with high prediction accuracy can be obtained.

Although embodiments of the present invention have been described in detail above with reference to the drawings, specific configurations are not limited to the embodiments and various design changes and the like can also be made without departing from the scope and spirit of the present invention.

What is claimed is:

1. A model setting support device comprising:
a model learning unit having a plurality of learning models for estimating an objective variable indicating performance of a product from an explanatory variable group including a plurality of types of explanatory variables indicating at least a material or design matter of the product and configured to learn each of the plurality of learning models using training data including a dataset including the explanatory variable group and a target value of the objective variable;
an analysis unit configured to execute first analysis for calculating a predicted value of the objective variable from the explanatory variable group and calculating prediction accuracy of the predicted value on the basis of the target value of the objective variable and second analysis for deriving a degree of contribution of the explanatory variable to the objective variable, for each learning model; and
a learning result processing unit configured to output learning result information indicating the prediction accuracy and the contribution degree for each learning model.

2. The model setting support device according to claim 1,
wherein the model learning unit learns the plurality of learning models for each objective variable,
wherein the analysis unit executes the first analysis and the second analysis for each objective variable, and
wherein the learning result processing unit outputs the learning result information for each objective variable.

3. The model setting support device according to claim 2, comprising a learning setting unit configured to select a learning model for predicting the objective variable in accordance with an input manipulation,
wherein the model learning unit learns the selected learning model without learning an unselected learning model.

4. The model setting support device according to claim 1, comprising a learning setting unit configured to select an explanatory variable in accordance with an input manipulation,
wherein the model learning unit learns the learning model including an explanatory variable selected from the training data without including an unselected explanatory variable.

5. The model setting support device according to claim 2, comprising a learning setting unit configured to retrieve a hyperparameter for learning the learning model with higher prediction accuracy for each learning model.

6. The model setting support device according to claim 1, wherein the product is a battery.

7. A computer-readable non-transitory storage medium storing a program for causing a computer to function as the model setting support device according to claim 1.

8. A model setting support method to be executed by a model setting support device having a plurality of learning models for estimating an objective variable indicating performance of a product from an explanatory variable group including a plurality of types of explanatory variables indicating at least a material or design matter of the product, the model setting support method comprising:
learning, by the model setting support device, each of the plurality of learning models using training data including a dataset including the explanatory variable group and a target value of the objective variable;
executing, by the model setting support device, first analysis for calculating a predicted value of the objective variable from the explanatory variable group and calculating prediction accuracy of the predicted value on the basis of the target value of the objective variable and second analysis for deriving a degree of contribution of the explanatory variable to the objective variable, for each learning model; and
outputting, by the model setting support device, learning result information indicating the prediction accuracy and the contribution degree for each learning model.
